(19) United States
(12) Patent Application Publication
(10) Pub. No.: US 2022/0076115 A1
(43) Pub. Date: Mar. 10, 2022

(54) DATA PROCESSING BASED ON NEURAL NETWORK

(71) Applicant: SK hynix Inc., Icheon-si (KR)

(72) Inventor: Ji Hoon NAM, Icheon-si (KR)

(21) Appl. No.: 17/168,369

(22) Filed: Feb. 5, 2021

(30) Foreign Application Priority Data
Sep. 10, 2020 (KR) 10-2020-0115911

(51) Int. Cl. G06N 3/08; G06N 3/04

(52) U.S. Cl. CPC G06N 3/08; G06N 3/04

(57) ABSTRACT

Devices and methods for improving the performance of a data processing system that receives an input data comprising a training data for a neural network are described. An example system includes a plurality of accelerators, each of which is configured to perform a plurality of epoch segment processes, share, after performing at least one of the plurality of epoch segment processes, gradient data associated with a loss function with other accelerators, and update a weight of the neural network based on the gradient data. In some embodiments, each of the plurality of accelerators are further configured to adjust a precision of the gradient data based on at least one of a variance of the gradient data for the input data and a total number of the plurality of epoch segment processes, and transmit precision-adjusted gradient data to the other accelerators.

### CROSS-REFERENCE TO RELATED APPLICATION

This patent document claims priority to and benefits of Korean Patent Application Number 10-2020-0115911, filed on Sep. 10, 2020, in the Korean Intellectual Property Office, which is incorporated herein by reference in its entirety.

### TECHNICAL FIELD

The technology disclosed in this patent document generally relates to data processing technology, and more particularly, to a data processing system configured to use a neural network operation and an operating method thereof.

### BACKGROUND

Artificial intelligence technology, which relates to methods of imitating intellectual abilities of human beings, has been increasingly applied to image recognition, natural language processing, autonomous vehicles, automation systems, medical care, security, finance, and other applications.

An artificial neural network is one way to implement artificial intelligence. The goal of the artificial neural network is to increase the problem solving ability of machines; that is, provide inferences based on learning through training. However, as the accuracy of the output inference increases, the amount of computation, the number of memory accesses, and the amount of data transferred consequently increase.

This increase in required resources may cause a reduction in speed, an increase in power consumption, and other benefits, and thus system performance may deteriorate.

### SUMMARY

Embodiments of the disclosed technology, among other features and benefits, can be implemented based on processing via an artificial neural network in ways that improve the performance of data processing systems that are implemented using multiple accelerators. In an example, this advantage may be achieved by varying the precision of data before the data is exchanged by the multiple accelerators.

In an embodiment for implementing the disclosed technology, a data processing system may include: a plurality of accelerators configured to receive an input data comprising a training data for a neural network, wherein each of the plurality of accelerators is configured to perform a plurality of epoch segment processes, share, after performing at least one of the plurality of epoch segment processes, gradient data associated with a loss function with other accelerators, and update a weight of the neural network based on the gradient data. The loss function comprises an error between a predicted value output by the neural network and an actual value. Each of the plurality of accelerators includes a precision adjuster configured to adjust a precision of the gradient data based on at least one of a variance of the gradient data for the input data and a total number of the plurality of epoch segment processes, and transmit precision-adjusted gradient data to the other accelerators, and a circuit configured to update the neural network based on at least one of the input data, the weight, and the gradient data.

In another embodiment for implementing the disclosed technology, an operating method of a data processing system which includes a plurality of accelerators configured to receive an input data comprising a training data for a neural network, wherein each of the plurality of accelerators is configured to perform a plurality of epoch segment processes, share, after performing at least one of the plurality of epoch segment processes, gradient data associated with a loss function with other accelerators, and update a weight of the neural network based on the gradient data, wherein the loss function comprises an error between a predicted value output by the neural network and an actual value, and wherein the method comprises: each of the plurality of accelerators: adjusting a precision of the gradient data based on at least one of variance of the gradient data for the input data and a total number of the plurality of epoch segment processes, transmitting the precision-adjusted gradient data to the other accelerators, and updating the neural network model based on at least one of the input data, the weight, and the gradient data.

In yet another embodiment for implementing the disclosed technology, a data processing system may include: a plurality of s circuits coupled to form a neural network for data processing including a plurality of accelerators configured to receive an input data comprising a training data for the neural network. Each of the plurality of accelerators which is configured to receive at least one mini-batch that is generated by dividing the training data by a predetermined batch size, share precision-adjusted gradient data with other accelerators for each epoch segment processes, perform a plurality of epoch segment processes which updating a weight of the neural network based on the shared gradient data, and wherein the gradient data is associated with a loss function comprising an error between a predicted value output by the neural network and an actual value.

In yet another embodiment of the present disclosure, a data processing system may include: a plurality of accelerators, each of which is configured to repeatedly perform an epoch process, which shares gradient data of a loss function that an error between a predicted value through a neural network and an actual value is quantified, with other remaining accelerators and updates a weight according to the gradient data, a set number of times. Each of the plurality of accelerators may include a precision adjuster configured to adjust precision of the gradient data based on at least one of variance of the gradient data for input data calculated through previous learning iteration and the set number of times in the epoch process and transmit the precision-adjusted gradient data to the other accelerators; and an operation circuit configured to generate a neural network model based on at least the input data, the weight, and the gradient data.

In yet another embodiment of the present disclosure, an operating method of a data processing system which includes a plurality of accelerators, each of which is configured to repeatedly perform an epoch process, which shares gradient data of a loss function that an error between a predicted value through a neural network and an actual value is quantified, with other remaining accelerators and updates a weight according to the gradient data, a set number of times, the method may include: each of the plurality of accelerators adjusting precision of the gradient data based on at least one of variance of the gradient data for input data calculated through previous learning iteration and the set number of times in the epoch process; the accelerator transmitting the precision-adjusted gradient data to the other accelerators; and the accelerator generating a neural network model by repeatedly performing the epoch process the set number of times based on at least the input data, the weight, and the gradient data.

These and other features, aspects, and embodiments are described in more detail in the description, the drawings and the claims.

### BRIEF DESCRIPTION OF THE DRAWINGS

The above and other aspects, features and advantages of the subject matter of the present disclosure will be more clearly understood from the following detailed description taken in conjunction with the accompanying drawings.

FIGS. 1A and 1B are diagrams illustrating the data processing of an example artificial neural network in accordance with an embodiment of the disclosed technology.

FIG. 2 is a diagram illustrating an example training process in accordance with an embodiment of the disclosed technology

FIG. 3 is a diagram illustrating an example learning (or training) cycle of a neural network model in accordance with an embodiment of the disclosed technology.

FIG. 4 is a diagram illustrating an example of a distributed neural network learning system architecture in accordance with an embodiment of the disclosed technology

FIG. 5 is a diagram illustrating another example of a distributed neural network learning system architecture in accordance with an embodiment of the disclosed technology.

FIG. 6 is a diagram illustrating an example configuration of an accelerator in accordance with an embodiment of the disclosed technology.

FIG. 7A is a diagram illustrating an example configuration of a precision adjuster in accordance with an embodiment of the disclosed technology.

FIG. 7B illustrates an example set of operations performed by the precision adjuster illustrated in FIG. 7A, in accordance with an embodiment of the disclosed technology.

FIG. 8 illustrates an example of a stacked semiconductor apparatus in accordance with an embodiment of the disclosed technology.

FIG. 9 illustrates another example of a stacked semiconductor apparatus in accordance with an embodiment of the disclosed technology.

FIG. 10 illustrates yet another example of a stacked semiconductor apparatus in accordance with an embodiment of the disclosed technology.

FIG. 11 illustrates an example of a network system that includes a data storage device in accordance with an embodiment of the disclosed technology.

### DETAILED DESCRIPTION

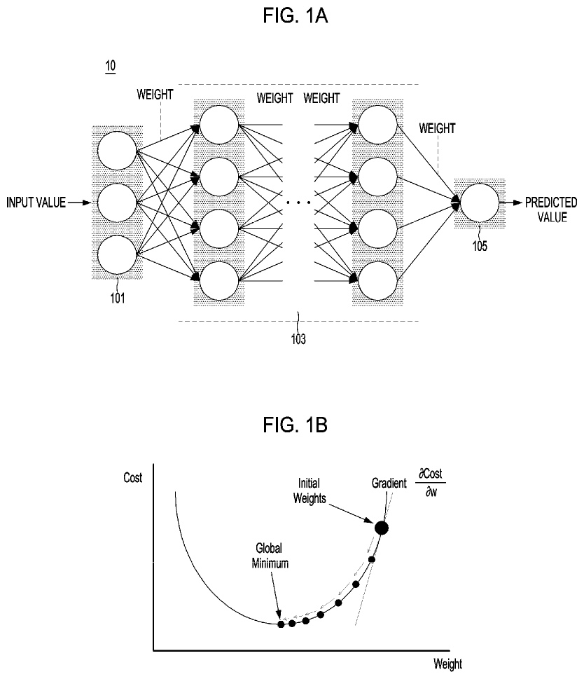

FIGS. 1A and 1B are diagrams illustrating the data processing of an example artificial neural network in accordance with an embodiment of the disclosed technology.

As illustrated in FIG. 1A, an artificial neural network 10 may include an input layer 101, at least one hidden layer 103, and an output layer 105, and each of the layers 101, 103, and 105 may include at least one node.

The input layer 101 is configured to receive data (an input value) that is used to derive a predicted value (an output value). When N input values are received, the input layer 101 may include N nodes. During the training process of the artificial neural network, the input value is the (known) training data, whereas during an inference process of the artificial neural network, the input value is the data that is to be recognized (recognition target data).

A hidden layer 103 between the input layer 101 and the output layer 105 is configured to receive input values from the input nodes in the input layer 101, calculate a weighted sum based on weight parameters or coefficients assigned to the nodes in the neural network, apply the weighted sum to a transfer function, and transmit the transfer function to the output layer 105.

The output layer 105 is configured to determine an output pattern using features determined in the hidden layer 103, and output the predicted value.

In some embodiments, the input nodes, the hidden nodes, and the output node are all coupled through a network having weights. In an example, the hidden layer 103 may learn or derive the features hidden in the input values through a weight parameter and a bias parameter for a node (that are referred to as a weight and a bias, respectively).

The weight parameter is configured to adjust the connection strength between the nodes. For example, the weights can adjust the influence of an input signal of each node on an output signal.

In some embodiments, an initial value for the weight parameter, for example, can be arbitrarily assigned and may be adjusted to a value that best fits the predicted value through a learning (training) process.

In some embodiments, the transfer function that is transmitted to the output layer is an activation function that is activated to transmit an output signal to a next node when the output signal of each node in the hidden layer 103 is equal to or greater than a threshold value.

The bias parameter is configured to adjust a degree of activation at each node.

The artificial neural network implementation includes a training process that generates a learning or training model by determining multiple parameters, including the weight parameter and the bias parameter, such that the output data is similar to the input training data. The artificial neural network implementation further includes an inference process that processes the input recognition target data using the learning or training model generated in the training process.

In some embodiments such as the example shown in FIG. 1B, the training process may include forming a training data set, obtaining the gradient of the loss function with respect to a parameter such as the weight parameter in the illustrated example in FIG. 1B, wherein the weight and the bias are applied to the training data to reduce a value of the loss function, updating the weight to a gradient direction that minimizes the loss function, and performing the steps of obtaining the gradient and updating the weight a predetermined number of times.

In some embodiments, the loss function is a difference between the predicted value output from the output layer 105 and the actual value. For example, the loss function may be mathematically represented by one or more error indicating parameters as a mean square error (MSE), a cross entropy error (CEE), or other forms of parameters. In an example, the MSE loss function may be represented with a quadratic function (convex function) with respect to the weight parameter as illustrated in FIG. 1B.

In the example loss function illustrated in FIG. 1B, a point (global minimum) where the gradient is zero (0) exists and the loss function may converge to the global minimum. Accordingly, the global minimum can be determined using differentiation, which computes a gradient of a tangent to the loss function. A specific example of the method of determining the global minimum is described below.

First, an initial weight may be selected and the gradient of the loss function is calculated at the selected initial weight.

To determine the next point of the loss function, the weight is updated by applying a learning coefficient to the initial weight, which results in the weight moving to the next point. In an example, in order to determine the global minimum as quickly as possible, the weight may be configured to move in an opposite direction (negative direction) to that of the gradient.

Repeating the above operations results in the gradient gradually approaching the minimum value, and as a result, the weight converges to the global minimum as shown in FIG. 1B.

The process of finding the optimal weight such that a loss function is gradually minimized by repeatedly performing a series of operations is referred to as the gradient descent (GD) method. In an example, the series of operations include computing a current weight based on the gradient of the loss function and updating the weight by applying a learning coefficient to gradient.

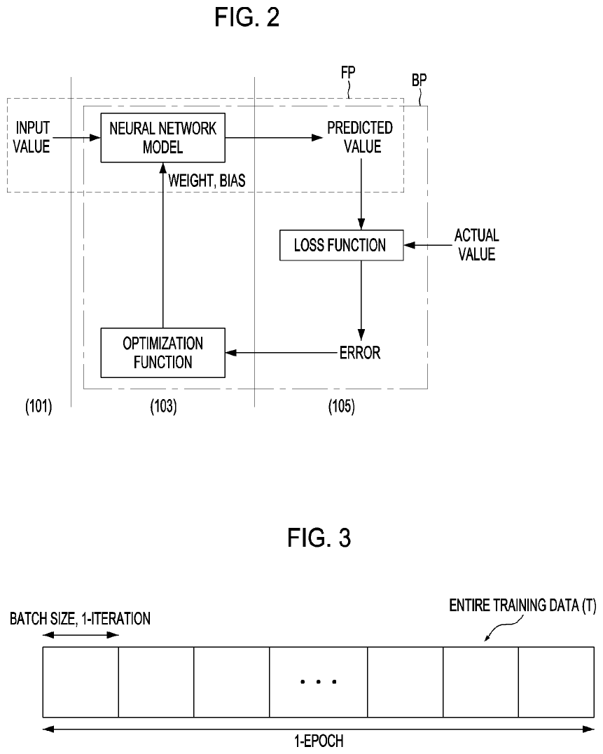

FIG. 2 is a diagram illustrating an example training process in accordance with an embodiment of the disclosed technology.

As illustrated in FIG. 2, in a forward propagation (FP) process which operates or proceeds in a forward direction pointed from the input layer 101 towards the output layer 105, the neural network model of the hidden layer 103, which receives data from the input layer 101, outputs the predicted value using the initialized weight and bias.

The error between the predicted value and the actual value may be calculated through the loss function in the output layer 105.

In a back propagation (BP) process, which operates or proceeds in a backward direction pointed from the output layer 105 to the input layer 101, the weight and bias are updated in a direction that minimizes the error of the loss function using the gradient value of the loss function.

As described above, the loss function may be a function wherein the difference (or error) between the actual value and the predicted value is quantified for the determination of the weight. In an example, an increasing error results in an increase in the value of the loss function. The process of finding the weight and bias that minimizes the value of the loss function is referred to as the training process.

One implementation of a gradient descent (GD) method as an optimization method for finding the optimal weight and bias can include repeatedly performing the operations of obtaining the gradient of the loss function for one or more parameters (e.g., the weight and/or the bias) and continuously moving a parameter in a direction that lowers the gradient until the parameter reaches a minimum value. In some implementations, such a GD method may be performed on the entire input data, and thus, a long processing time may be required.

A stochastic gradient descent (SGD) method is an optimization method that calculates the gradient for only one piece of data that is randomly selected (instead of the entire data in the above example) to improve the calculation speed when the value of the one or more parameters is adjusted.

Unlike the above example GD method which performs calculation on the entire data or the SGD method which performs calculation on the one piece of data, an optimization method that adjusts the value of the one or more parameters by calculating gradients for a certain amount of data is referred to as a mini-batch stochastic gradient descent (mSGD) method. The mSGD method has a faster computation speed than the GD method and is more stable than the SGD method.

FIG. 3 is a diagram illustrating an example learning (or training) cycle of a neural network model in accordance with an embodiment of the disclosed technology.

In some embodiments, a cycle in which the neural network model processes the entire training data using a single FP process and a single BP process is referred to as “1-epoch”. In an example, the weight (or bias) may be updated once during 1-epoch.

When simultaneously processing the entire training data, T, in 1-epoch, even a high performance system may be adversely affected; the system load may increase and the processing speed may reduce. In order to mitigate these effects, the training data, T, is divided into batches (or mini-batches) and processed by 1-epoch after dividing the 1-epoch into a plurality of epoch segments, I, which reduces the computational requirements. In this framework, a batch or mini-batch refers to a data set processed in one epoch segment, and the amount of data included in one batch is referred to as a batch size B. In some embodiments, each of the epoch segment may be referred to as an “iteration”.

Herein, 1-epoch now includes learning all the mini-batches (for example, T/B=I), wherein the training data, T, is divided by the batch size B and processed over the plurality of epoch segments, I.

For example, the neural network model may be updated by performing the epoch segment process a predetermined number of times that is based the plurality of mini-batches I, which are determined by dividing the entire training data T by a set batch size B. The operations of each epoch segment process include calculating the gradient of the loss function, as part of the learning (or training) stage, for each mini-batch, and integrating the gradients calculated over the epoch segments.

In some embodiments, the batch size B, the epoch repetition number (i.e., the number of epoch segments), and other parameters are determined based on the performance, the required accuracy, and the speed of the system.

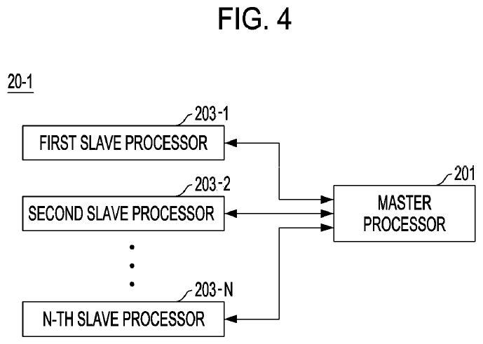

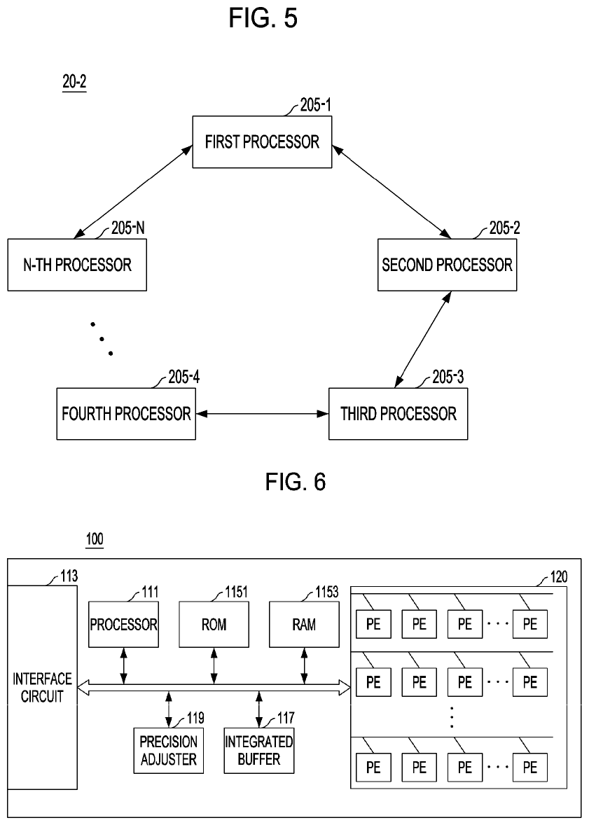

FIGS. 4 and 5 are diagrams illustrating distributed neural network learning or training system architectures in accordance with embodiments of the disclosed technology.

In many applications, the data to be trained or inferred is vast, and it may be difficult to train this amount of data in one neural network processing apparatus (e.g., computer, server, accelerator, and the like). Accordingly, embodiments of the disclosed technology include a data processing system for a distributed neural network, which can train on a plurality of data sets (mini-batches), obtained by dividing the entire training data, in parallel in a plurality of neural network processing apparatuses (each of which perform an epoch segment process) and integrate the results for the training stage.

As illustrated in FIG. 4, an example data processing system 20-1 includes at least one master processor 201 and a plurality of slave processors 203-1 to 203-N.

The plurality of slave processors 203-1 to 203-N may receive the mini-batches and perform a training (learning) process on input data included in the mini-batches in parallel. For example, if the entire training data is divided into N mini-batches, the plurality of epoch segments for the mini-batches constituting 1-epoch may be processed in parallel in separate processors 203-1 to 203-N.

In each epoch segment, each of the slave processors 203-1 to 203-N outputs the predicted value by applying the weight and the bias to the input data, and updating the weight and the bias in a gradient direction of the loss function such that the error between the predicted value and the actual value is minimized.

In some embodiments, the weights and the biases of the epoch segments calculated in the slave processors 203-1 to 203-N may be integrated in every epoch, and the slave processors 203-1 to 203-N may have the same weight and bias as each other after the completion of each epoch. The resultant neural network updates the weight and the bias by performing a plurality of epoch segment processes in parallel.

In some embodiments, the gradients of the loss functions of the slave processors 203-1 to 203-N that were calculated in each epoch segment (during the training stage) may be shared and reduced (for example, averaged) in the master processor 201 and subsequently distributed to the slave processors 203-1 to 203-N.

In some embodiments, the master processor 201 may also receive the mini batch and perform the epoch segment process together with the slave processors 203-1 to 203-N.

As illustrated in FIG. 5, a data processing system 20-2 includes a plurality of processors 205-1 to 205-N without any of the processors being classified as a master or a slave.

The processors 205-1 to 205-N illustrated in FIG. 5 receive the mini-batches and perform epoch segment processes on the input data included in the mini-batches in parallel. The gradients of the loss functions derived as the results of the epoch segment processing of the processors 205-1 to 205-N may be shared among the processors 205-1 to 205-N.

When the gradients of the loss functions are shared among the processors 205-1 to 205-N, the processors 205-1 to 205-N may reduce the gradients. As a result, the processors 205-1 to 205-N of the neural network can update the weight and bias by processing the next epoch (for a subsequent training stage) with the same weight and bias.

In some embodiments, the plurality of processors illustrated in FIGS. 4 and 5 may be coupled to each other through a bus or may be coupled through a fabric network such as Ethernet, a fiber channel, or InfiniBand. In an example, the processors may be implemented with a hardware accelerator that is specifically optimized for neural network operation.

FIG. 6 is a diagram illustrating an example configuration of an accelerator in accordance with an embodiment of the disclosed technology.

As illustrated in FIG. 6, the accelerator 100 includes a processor 111, an interface circuit 113, a read only memory (ROM) 1151, a random access memory (RAM) 1153, an integrated buffer 117, a precision adjustor 119, and an operation circuit 120 that includes processing circuits each labeled as “PE” for “process element.”

In some implementations, the processor 111 controls the operation circuit 120, the integrated buffer 117, and the precision adjuster 119 to allow a program code of a neural network application process-requested from a host (not shown) to be executed.

The interface circuit 113 provides an environment that the accelerator 100 may communicate with another accelerator, an input/output (I/O) circuit and a system memory on a system mounted with the accelerator 100, and the like. For example, the interface circuit 113 may be a system bus interface circuit such as a peripheral component interconnection (PCI), a PCI-express (PCI-E), or a fabric interface circuit, but this is not limited thereto.

The ROM 1151 stores program codes required for an operation of the accelerator 100 and may also store code data and the like used by the program codes.

The RAM 1153 stores data required for the operation of the accelerator 100 or data generated through the accelerator 100.

The integrated buffer 117 stores hyper parameters of the neural network, which include I/O data, an initial value of the parameter, the epoch repetition number, an intermediate result of an operation output from the operation circuit 120, and the like.

In some embodiments, the operation circuit 120 is configured to perform process near memory (PNM) or process in memory (PIM), and includes a plurality of process elements (PEs).

The operation circuit 120 may perform a neural network operations, e.g., matrix multiply, accumulation, normalization, pooling, and/or other operations, based on the data and the one or more parameters. In some embodiments, the intermediate result of the operation circuit 120 may be stored in the integrated buffer 117 and the final operation result may be output through the interface circuit 113.

In some embodiments, the operation circuit 120 performs an operation with preset precision. The precision of the operation may be determined according to a data type that represents the operation result calculated for updating the neural network model.

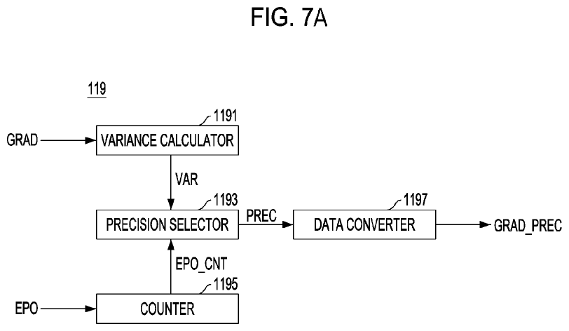

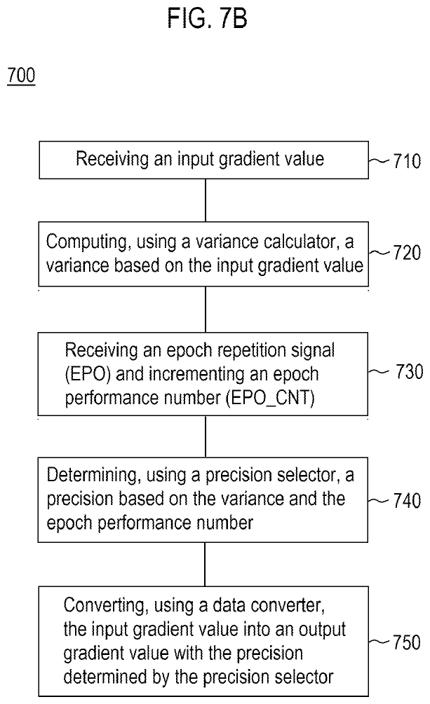

FIG. 7A is a diagram illustrating an example configuration of a precision adjuster in accordance with an embodiment of the disclosed technology.

The example illustrated in FIG. 7A uses a data type that is divided into FP32, FP16, BF16, FP8, in ascending order of precision as shown in Table 1.

TABLE 1

| Data | Number of | Number of | Number of fraction |
|---|---|---|---|
| type | sign (S) bits | exponential bits | bits |
| FP32 | 1 | 8 | 23 |
| FP16 | 1 | 5 | 10 |
| BF16 | 1 | 8 | 7 |
| FP8 | 1 | 4 | 3 |

The FP32 data type indicates a 32-bit precision (single precision) of data type which uses 1 bit for sign (S) representation, 8 bits for exponential representation, and 23 bits for fraction representation.

The FP16 data type indicates a 16-bit precision (semi-precision) of data type which uses 1 bit for sign (S) representation, 5 bits for exponential representation, and 10 bits for fraction representation.

The BF16 data type indicates a 16-bit precision of data type which uses 1 bit for sign (S) representation, 8 bits for exponential representation, and 7 bits for fraction representation.

The FP8 data type indicates an 8-bit precision of data type which uses 1 bit for sign (S) representation, 4 bits for exponential representation, and 3 bits for fraction representation.

For these data types, the higher precision results in the more accurate representation of the operation. When the plurality of accelerators performs the variance operation while sharing the gradients with each other, the data having high precision may be transmitted and received. In these cases, the processing speed of the neural network may degrade due to the large amount of data being transferred between accelerators.

In some embodiments, the precision of the gradient calculated in the operation circuit 120 may be set as the default value to, for example, FP32; the accelerator 100 includes the precision adjuster 119 that is configured to adjust the precision of the gradient of the loss function before its exchange between the accelerators 100 based on the training process state.

In some embodiments, the precision adjuster 119 calculates the variance for the gradient of the loss function for each input data processed during the epoch segment process of the previous training stage, and determines the precision based on the variance value and at least one set threshold value. Table 2 shows an example of the precision being determined based on the variance.

In Table 2, and without loss of generality, the thresholds values are assumed to satisfy the relationship TH0>TH1>TH2.

TABLE 2

| | Relationship between variance |
|---|---|
| Precision | (VAR) and threshold value (TH) |
| FP8 | VAR > TH0 |
| BF16 | TH0 > VAR > TH1 |
| FP16 | TH1 > VAR > TH2 |
| FP32 | TH2 > VAR |

In some embodiments, the variance of the gradients for the input data in an initial learning stage may have a relatively large value, and the variance of the gradients for the input data may decrease as the epoch is repeated.

In these cases, in the initial learning stage with the high variance, the plurality of accelerators may share the gradient values with low precision so that the data exchanged may be reduced and the speed of the data exchange is increased.

As the training or learning stage is repeated, the plurality of accelerators share the gradient values with higher precision so that the optimal weight and bias values may be determined.

In some embodiments, the precision adjuster 119 is configured to adjust the precision based on the epoch repetition number. Table 3 shows an example of the precision being selected based on a comparison between the epoch performance number EPO_CNT (the number of epochs processed) and the total epoch repetition number T_EPO.

TABLE 3

| Precision | Epoch performance number (EPO_CNT) |
|---|---|
| FP8 | EPO_CNT < [(1/4)*T_EPO] |
| BF16 | [(1/4)*T_EPO] < EPO_CNT < [(2/4)*T_EPO] |
| FP16 | [(2/4)*T_EPO] < EPO_CNT < [(3/4)*T_EPO] |
| FP32 | EPO_CNT > [(3/4)*T_EPO] |

In some embodiments, in an initial learning or training stage when there is a large difference between the gradients of the loss functions calculated in the accelerators, the data may be exchanged with low precision to improve the operation speed, and in a later learning or training stage, the data may be exchanged with higher precision to improve the accuracy of the operation.

In some embodiments, the precision adjuster 119 adjusts the precision based on the gradient of the loss function and the epoch performance number.

In some embodiments, when an accelerator receives a gradient that has a precision that has been adjusted in every epoch segment process, the precision adjuster 119 may convert the received data type into a data type with a precision set to default precision of the operation circuit 120, and then provide the converted data type to the operation circuit 120.

Referring back to FIG. 7A, the precision adjuster 119 includes a variance calculator 1191, a precision selector 1193, a counter 1195, and a data converter 1197.

In some embodiments, the mini-batch is input to the epoch segment, and the gradient, GRAD, of the loss function for each input data included in the mini-batch is calculated.

The variance calculator 1191 calculates the variance, VAR, from the gradient, GRAD, of each input data and provides the calculated variance to the precision selector 1193.

Whenever the epoch segment is repeated the set number of times (in the case where the training stage is performed multiple times), the counter 1195 receives an epoch repetition signal, EPO, increments the epoch performance number, EPO_CNT, and provides the incremented value to the precision selector 1193.

The precision selector 1193 outputs a precision selection signal, PREC, based on at least one of the variance, VAR, and the epoch performance number, EPO_CNT.

The data converter 1197 converts the data type of the gradient, GRAD, which is to be exchanged with the other accelerators, based on the precision selection signal, PREC, and outputs the converted gradient data, GRAD_PREC. Furthermore, the data converter 1197 may receive the precision-adjusted gradient, GRAD_PREC, data from the other accelerators and convert the received data into the gradient, GRAD, data having the data type set to the default precision value of the operation circuit 120.

As described above, the amount of data exchanged between the distributed accelerators or processors can be adjusted based on the training process state. This advantageously prevents speed degradation and bottlenecks due to data transmission overhead.

FIG. 7B illustrates an example set of operations 700 performed by the precision adjuster illustrated in FIG. 7A. As s illustrated therein, the set of operation 700 includes, at operation 710, receiving an input gradient value.

The set of operations 700 includes, at operation 720, computing, using a variance calculator, a variance based on the input gradient value.

The set of operations 700 includes, at operation 730, receiving an epoch repetition signal (EPO) and incrementing an epoch performance number (EPO_CNT).

The set of operations 700 includes, at operation 740, determining, using a precision selector, a precision based on the variance and/or the epoch performance number. In some embodiments, the precision is determined based on comparing the variance to a threshold (e.g., as described in Table 2). In other embodiments, the precision is determined based on the epoch performance number (e.g., as described in Table 3).

The set of operations 700 includes, at operation 750, converting, using a data converter, the input gradient value into an output gradient value with the precision determined by the precision selector.

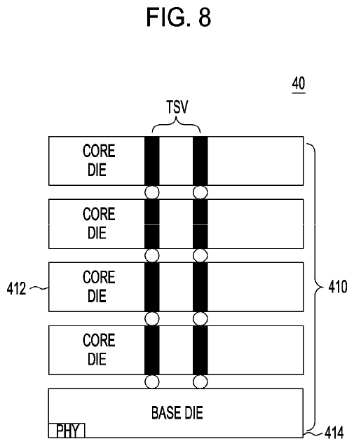

In light of the above examples of various features for neutral network processing of data, FIGS. 8 to 10 illustrate examples of stacked semiconductor apparatuses for implementing hardware for the disclosed technology.

The stacked semiconductor examples shown in FIGS. 8 to 10 include multiple dies that are stacked and connected using through-silicon vias (TSV). Embodiments of the disclosed technology are not limited thereto.

FIG. 8 illustrates an example of a stacked semiconductor apparatus 40 that includes a stack structure 410 in which a plurality of memory dies are stacked. In an example, the stack structure 410 may be configured in a high bandwidth memory (HBM) type. In another example, the stack structure 410 may be configured in a hybrid memory cube (HMC) type in which the plurality of dies are stacked and electrically connected to one another via through-silicon vias (TSV), so that the number of input/output units is increased, which results in an increase in bandwidth.

In some embodiments, the stack structure 410 includes a base die 414 and a plurality of core dies 412.

As illustrated in FIG. 8, the plurality of core dies 412 are stacked on the base die 414 and electrically connected to one another via the through-silicon vias (TSV). In each of the core dies 412, memory cells for storing data and circuits for core operations of the memory cells are disposed.

In some embodiments, the core dies 412 may be electrically connected to the base die 414 via the through-silicon vias (TSV) and receive signals, power and/or other information from the base die 414 via the through-silicon vias (TSV).

In some embodiments, the base die 414, for example, includes the accelerator 1000 illustrated in FIG. 6. The base die 414 may perform various functions in the stacked semiconductor apparatus 40, for example, memory management functions such as power management, refresh functions of the memory cells, or timing adjustment functions between the core dies 412 and the base die 414.

In some embodiments, as illustrated in FIG. 8, a physical interface area PHY included in the base die 414 is an input/output area of an address, a command, data, a control signal or other signals. The physical interface area PHY may be provided with a predetermined number of input/output circuits capable of satisfying a data processing speed required for the stacked semiconductor apparatus 40. A plurality of input/output terminals and a power supply terminal may be provided in the physical interface area PHY on the rear surface of the base die 414 to receive signals and power required for an input/output operation.

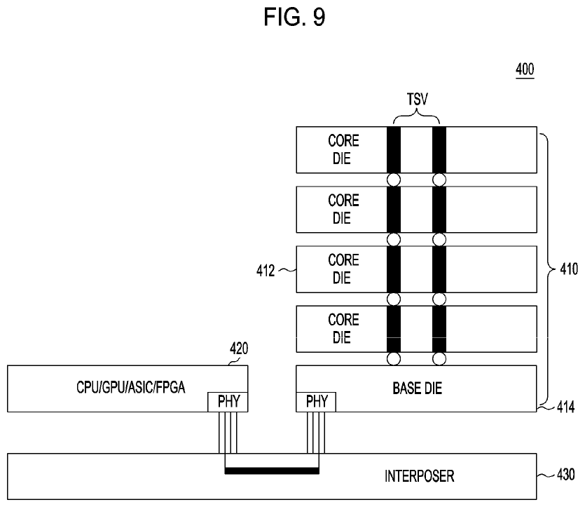

FIG. 9 illustrates a stacked semiconductor apparatus 400 may include a stack structure 410 of a plurality of core dies 412 and a base die 414, a memory host 420, and an interface substrate 430. The memory host 420 may be a CPU, a GPU, an application specific integrated circuit (ASIC), a field programmable gate arrays (FPGA), or other circuitry implementations.

In some embodiments, the base die 414 is provided with a circuit for interfacing between the core dies 412 and the memory host 420. The stack structure 410 may have a structure similar to that s described with reference to FIG. 8.

In some embodiments, a physical interface area PHY of the stack structure 410 and a physical interface area PHY of the memory host 420 may be electrically connected to each other through the interface substrate 430. The interface substrate 430 may be referred to as an interposer.

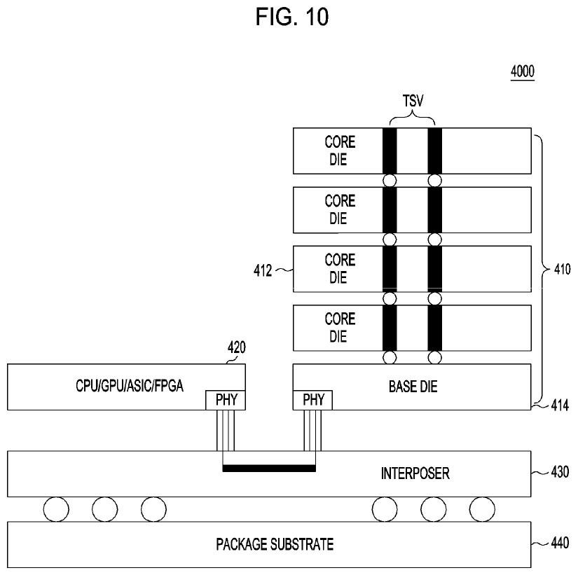

FIG. 10 illustrates a stacked semiconductor apparatus 4000 in accordance with an embodiment of the disclosed technology.

As illustrated therein, the stacked semiconductor apparatus 4000 in FIG. 10 is obtained by disposing the stacked semiconductor apparatus 400 illustrated in FIG. 9 on a package substrate 440.

In some embodiments, the package substrate 440 and the interface substrate 430 may be electrically connected to each other through connection terminals.

In some embodiments, a system in package (SiP) type semiconductor apparatus may be implemented by stacking the stack structure 410 and the memory host 420, which are illustrated in FIG. 9, on the interface substrate 430 and mounting them on the package substrate 440 for the purpose of packaging.

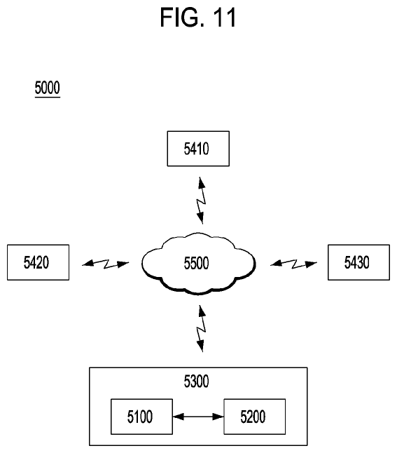

FIG. 11 is a diagram illustrating an example of a network system 5000 for implementing the neural network based processing of data of the disclosed technology. As illustrated therein, the network system 5000 includes a server system 5300 with data storage for the neural network based data processing and a plurality of client systems 5410, 5420, and 5430, which are coupled through a network 5500 to interact with the server system 5300.

In some implementations, the server system 5300 services data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

In some embodiments, the server system 5300 includes a host device 5100 and a memory system 5200. The memory system 5200 may include one or more of the neural network-based data processing system 10 shown in FIG. 1A, the stacked semiconductor apparatus 40 shown in FIG. 8, the stacked semiconductor apparatus 400 shown in FIG. 9, or the stacked semiconductor apparatus 4000 shown in FIG. 10, or combinations thereof.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A data processing system comprising:
a plurality of accelerators configured to receive an input data comprising a training data for a neural network,
wherein each of the plurality of accelerators is configured to
perform a plurality of epoch segment processes,
share, after performing at least one of the plurality of epoch segment processes, gradient data associated with a loss function with other accelerators, and
update a weight of the neural network based on the gradient data,
wherein the loss function comprises an error between a predicted value output by the neural network and an actual value, and
wherein each of the plurality of accelerators includes:
a precision adjuster configured to adjust a precision of the gradient data based on at least one of a variance of the gradient data for the input data and a total number of the plurality of epoch segment processes, and transmit precision-adjusted gradient data to the other accelerators, and
a circuit configured to update the neural network based on at least one of the input data, the weight, and the gradient data.

2. The data processing system of claim 1, wherein the precision adjuster is configured to receive precision-adjusted gradient data from the other accelerators and convert the precision-adjusted gradient data into gradient data having an initial precision that corresponds to a default precision of the circuit.

3. The data processing system of claim 1, wherein each of the plurality of accelerators is configured to
receive at least one mini-batch that is generated by dividing the training data by a predetermined batch size, and
update the neural network by performing the plurality of epoch segment processes, which comprises performing the epoch segment process for the at least one mini-batch in parallel with the other accelerators and integrating results of the epoch segment processes.

4. The data processing system of claim 1, wherein each of the plurality of accelerators is configured, for a corresponding epoch segment process, to:
determine the predicted value by applying the weight to the input data,
calculate the gradient data of the loss function based on the error between the predicted value and the input data, and
update the weight in a direction that the gradient of the gradient data is reduced.

5. The data processing system of claim 4, wherein each of the plurality of accelerators is configured to calculate an average gradient data by receiving precision-adjusted gradient data from the other accelerators and update the weight at each of the plurality of epoch segment processes.

6. The data processing system of claim 1, wherein the plurality of accelerators includes:
at least one master accelerator configured to receive and integrate the precision-adjusted gradient data; and
a plurality of slave accelerators configured to update the weight based on receiving integrated gradient data from the master accelerator.

7. The data processing system of claim 1, wherein each of the plurality of accelerators share the precision-adjusted gradient data with the other accelerators and integrate the precision-adjusted gradient data.

8. The data processing system of claim 1, wherein the precision adjuster is configured to adjust the precision to a higher precision upon a determination that the variance of the gradient data is reduced.

9. The data processing system of claim 1, wherein the precision adjuster is configured to adjust the precision to a higher precision upon a determination that the number of the plurality of epoch segment processes is increased.

10. An operating method of a data processing system which includes a plurality of accelerators configured to receive an input data comprising a training data for a neural network, wherein each of the plurality of accelerators is configured to perform a plurality of epoch segment processes, share, after performing at least one of the plurality of epoch segment processes, gradient data associated with a loss function with other accelerators, and update a weight of the neural network based on the gradient data, wherein the loss function comprises an error between a predicted value output by the neural network and an actual value, and wherein the method comprises:
each of the plurality of accelerators:
adjusting a precision of the gradient data based on at least one of variance of the gradient data for the input data and a total number of the plurality of epoch segment processes,
transmitting the precision-adjusted gradient data to the other accelerators, and
updating the neural network model based on at least one of the input data, the weight, and the gradient data.

11. The method of claim 10, further comprising each of the plurality of accelerators receiving precision-adjusted gradient data from the other accelerators and converting the precision-adjusted s gradient data into gradient data having an initial precision that corresponds to a default precision of a circuit of the corresponding accelerator.

12. The method of claim 10, wherein updating the neural network includes:
receiving at least one mini-batch that is generated by dividing the training data by a predetermined batch size; and
performing the plurality of epoch segment processes for the at least one mini-batch in parallel with the other accelerators and integrating results of the epoch segment processes.

13. The method of claim 10, wherein the updating the neural network includes, for each epoch segment process:
determining the predicted value by applying the weight to the input data;
calculating the gradient data of the loss function based on the error between the predicted value and the input data; and
updating the weight in a direction that the gradient of the gradient data is reduced.

14. The method of claim 13, wherein the updating of the weight includes calculating an average gradient data by receiving precision-adjusted gradient data from the other accelerators and updating the weight at each of the plurality of epoch segment processes.

15. The method of claim 10, wherein the adjusting of the precision includes adjusting the precision to a higher precision upon a determination that the variance of the gradient data is reduced.

16. The method of claim 10, wherein the adjusting of the precision includes adjusting the precision to a higher precision upon a determination that the number of the plurality of epoch segment processes is increased.

17. A data processing system comprising:
a plurality of circuits coupled to form a neural network for data processing including a plurality of accelerators configured to receive an input data comprising a training data for the neural network,
wherein each of the plurality of accelerators which is configured to
receive at least one mini-batch that is generated by dividing the training data by a predetermined batch size,
share precision-adjusted gradient data with other accelerators for each epoch segment processes,
perform a plurality of epoch segment processes which updating a weight of the neural network based on the shared gradient data, and
wherein the gradient data is associated with a loss function comprising an error between a predicted value output by the neural network and an actual value.

18. The data processing system of claim 17, wherein a precision of the gradient data is configured to adjust based on at least one of a variance of the gradient data for the input data and a total number of the plurality of epoch segment processes.
